(19) United States
(12) Patent Application Publication
(10) Pub. No.: US 2013/0135472 A1
(43) Pub. Date: May 30, 2013

(54) INTELLIGENT DRIVING RECORDING AND INSPECTION SYSTEM

(71) Applicants: Bing-Fei Wu, Hsinchu (TW); Chao-Jung Chen, Hsinchu County (TW); Ying-Han Chen, Tainan (TW); Chung-Hsuan Yeh, Changhua County (TW)

(72) Inventors: Bing-Fei Wu, Hsinchu (TW); Chao-Jung Chen, Hsinchu County (TW); Ying-Han Chen, Tainan (TW); Chung-Hsuan Yeh, Changhua County (TW)

(73) Assignee: NATIONAL CHIAO TUNG UNIVERSITY, Hsinchu (TW)

(21) Appl. No.: 13/423,560

(22) Filed: Mar. 19, 2012

(30) Foreign Application Priority Data
Nov. 25, 2011 (TW) 100143302

(51) Int. Cl. H04N 7/18

(52) U.S. Cl. 348/148; 348/E07.085

(57) ABSTRACT

An intelligent driving recording and inspection system is introduced for recording a car's driving process and for a user to review the driving process in an intelligent manner. The system includes an image-capture unit for capturing image signals in the driving process; a sensing unit for generating event signals corresponding to all events encountered in the driving process, such as lane departure, close distance from a preceding car, changes in gravity sensing, and abnormalities shown in inside-car driving data; a processing unit for linking the event signals with and marking the same on corresponding image signals; a memory unit for storing the image signals and the event signals; and a inspection unit for a user to review the stored image signals marked with the event signals. Therefore, any event occurred in the driving process can be easily analyzed by reviewing the image signals having corresponding event signal marked thereon.

### CROSS-REFERENCE TO RELATED APPLICATION

This non-provisional application claims priority under 35 U.S.C. §119(a) on Patent Application No(s). 100143302 filed in Taiwan, R.O.C. on Nov. 25, 2011, the entire contents of which are hereby incorporated by reference.

### FIELD OF THE INVENTION

The present invention relates to a driving recording system, and more particularly to an intelligent driving recording and inspection system that allows a user to intelligently review and correctly analyze image signals captured closely before and after an event encountered by a car in the driving process.

### BACKGROUND OF THE INVENTION

Conventionally, a driving recorder is installed inside a car at a position close to the front windshield glass for continuously recording all images in the driving process. All the images captured in the driving process are recorded in a memory device, such as an SD card or a CF card, so that a user may read the images in the memory device for reviewing the driving process.

In addition, the images are continuously recorded in the memory device. To use the images to analyze his or her driving behavior or driving conditions, the user can only try to play back some segments of the whole recorded images corresponding to some estimated recording time points, or read the whole recorded images from the point of beginning Both of the above two manners for reviewing the recorded images are low-efficiency. That is, these inspected manners take a lot of time and the recorded images might not be able to reflect the exact driving behavior or driving condition that results in an event in the driving process. For instance, for a high-capacity memory device, the image recording might be as long as several hours or even several days, and it is impossible for the user to review and analyze all the recorded images one by one.

Moreover, the conventional driving recorder is usually set to record images continuously. Under this condition, the memory device is repeatedly used to record the images, and earlier images would be overwritten by newer images later. Therefore, it is inevitable some important images are undesirably overwritten and the user fails to find images corresponding to some driving behaviors and driving conditions.

It is therefore necessary to develop an intelligent driving recording and inspection system to overcome the drawbacks in the prior art driving recorders.

### SUMMARY OF THE INVENTION

A primary object of the present invention is to provide an intelligent driving recording and inspection system for capturing inside-car and outside-car image signals in a car's whole driving process, recording all events encountered by the car in the course of driving, and linking the events with corresponding image signals.

Another object of the present invention is to provide the above-mentioned intelligent driving recording and inspection system for associating the events and the image signals with map information, so that a user may review the image signals corresponding to an event via the map information.

A further object of the present invention is to provide the above-mentioned intelligent driving recording and inspection system for indicating different events on the map information by differently shaped or/and colored tags, so that a user may have an idea about his or her driving behavior and the car's driving conditions in the driving process via tagged points on the map information.

A still further object of the present invention is to provide the above-mentioned intelligent driving recording and inspection system for storing the image signals corresponding to any event and preventing them from being overwritten by subsequent newer image signals.

To achieve the above and other objects, the intelligent driving recording and inspection system according to the present invention is used to record a car's whole driving process and allows a user to review the driving process in an intelligent manner. The system includes an image-capture unit, a sensing unit, a processing unit, and a memory unit. The image-capture unit captures image signals in the driving process; the sensing unit is installed inside and/or outside the car for sensing events encountered by the car in the driving process and generating event signals corresponding to the events; the processing unit is electrically connected to the image-capture unit and the sensing unit for linking the event signals with corresponding image signals and marking the event signals on the corresponding image signals; and the memory unit is electrically connected to the processing unit for storing the image signals and the event signals.

Compared to prior art driving recorder systems, the intelligent driving recording and inspection system of the present invention relies on detection results from, for example, a lane departure warning system (LDWS), a forward collision warning system (FCW) and an accelerometer, G-sensor, and gravity-sensor, as well as on internal driving information indicating driving states and car's conditions, stores the image signals captured during driving and event signals generated corresponding to different events, such as lane departure, close distance from a preceding car or improper braking, in the map information or records them in a text file, and allows the user to access the map information or the text file to easily and quickly analyze any events by reviewing image signals marked with corresponding event signals, so that the user may know his or her driving behavior and the car's driving conditions in the driving process.

The intelligent driving recording and inspection system according to the present invention may further include a communication unit for directly or indirectly transmitting the image signals and event signals indicating the user's driving behavior and the car's driving conditions to a remote server or a cloud server, such as a driving control center, for judging and reminding the user of the driving behavior and the car's driving conditions to thereby achieve the purpose of safe driving.

According to the present invention, different events may be marked on the map information with differently shaped or/and colored tags. By using the image signals and the map information showing event tags at the same time, it is possible to correct, warn, and regulate the user's driving behavior.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of an intelligent driving recording and inspection system according to a first embodiment of the present invention;

FIGS. 2a and 2b are simulated views of outside-car and inside-car image signals, respectively, captured with the intelligent driving recording and inspection system of FIG. 1 in the course of driving;

FIG. 3 is a simulated view of an event signal generated by a sensing unit of the intelligent driving recording and inspection system of FIG. 1 in the course of driving;

FIG. 4 is simulated view of another event signal generated by the sensing unit of the intelligent driving recording and inspection system of FIG. 1 in the course of driving;

FIG. 5 is a conceptual view showing the states of different time memory blocks in a memory unit of the intelligent driving recording and inspection system of FIG. 1;

FIGS. 6a to 6c are conceptual views illustrating some examples of setting different time memory blocks of FIG. 5 to be read-only;

FIG. 7 is a block diagram of an intelligent driving recording and inspection system according to a second embodiment of the present invention;

FIG. 8 is a simulated view showing tagged points on map information provided by the intelligent driving recording and inspection system of FIG. 7;

FIG. 9 is a block diagram of an intelligent driving recording and inspection system according to a third embodiment of the present invention;

FIG. 10 is a simulated view of a inspection unit included in the intelligent driving recording and inspection system of FIG. 9; and

FIG. 11 is a block diagram of an intelligent driving process recording and reviewing system according to a fourth embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

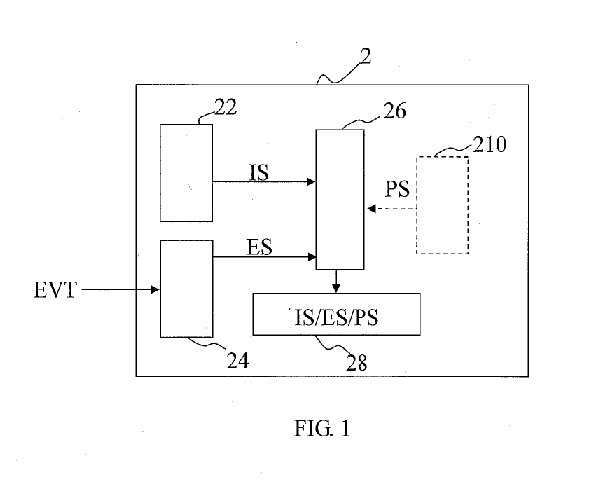

Refer to FIG. 1 that is a block diagram of an intelligent driving recording and inspection system 2 according to a first embodiment of the present invention. With the intelligent driving recording and inspection system 2, a user driving a car can record his or her whole driving process and the recorded driving process can be reviewed in an intelligent manner. Herein, the expression “driving process” is defined as the user's all driving behaviors and the car's all driving conditions occurred in the course of driving the car.

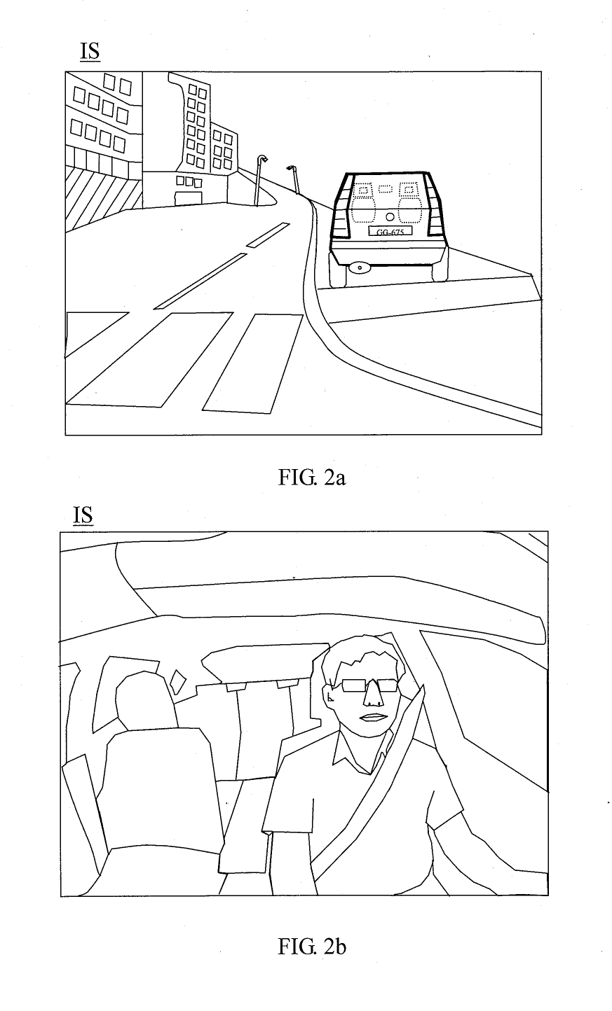

As shown, in the first embodiment, the intelligent driving recording and inspection system 2 includes an image-capture unit 22, a sensing unit 24, a processing unit 26, and a memory unit 28. The image-capture unit 22 captures outside-car and inside-car image signals IS in the whole driving process. FIGS. 2a and 2b are simulated views of two image signals IS corresponding to an outside-car image and an inside-car image, respectively, captured by the image-capture unit 22 from inside the car in the course of driving. The image-capture unit 22 may be, for example, a CCD-based or a CMOS-based camera device.

The sensing unit 24 may be installed inside the car and/or outside the car for sensing one single or multiple events EVT encountered by the car in the course of driving, and generating an event signal ES corresponding to each of the events EVT. For example, the event signal ES may correspond to the driver's some specific driving behavior or the car's some specific driving condition.

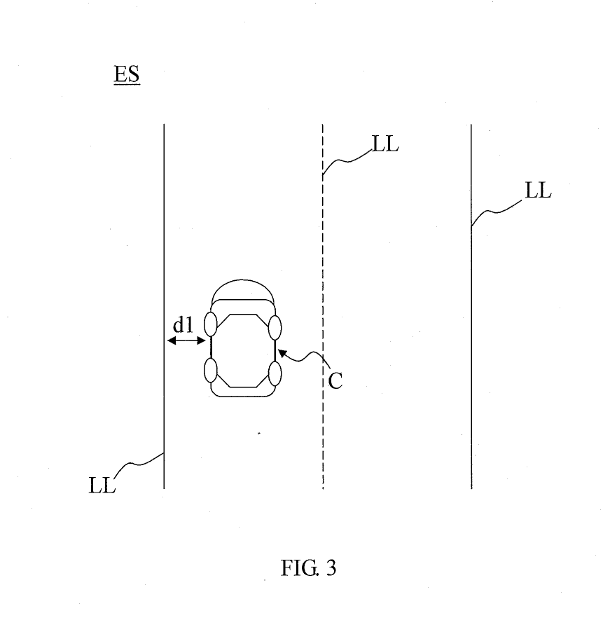

In an operable embodiment, the event signal ES may correspond to, for example, a lane departure event, in which the car departs from its lane in the course of driving. Please refer to FIG. 3. A distance d1 between a car C and a lane line LL can be detected with a lane departure warning system, and changes in the distance d1 can be found by counting the number of times the car C is moved across the lane line LL or detecting the direction in which the car C departs from the lane line LL, and the driver's driving behavior can be judged from the changes in the distance d1.

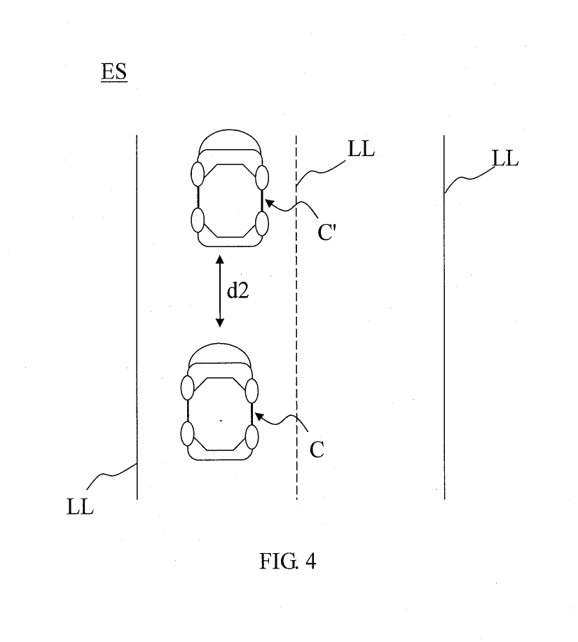

In another operable embodiment, the event signal ES may correspond to, for example, a distance d2 between the car C and a preceding car C′, which can be detected with a forward collision warning system, as shown in FIG. 4; and the event signal ES corresponding to the distance d2 can also be used to judge the driver's driving behavior.

In a further operable embodiment, the event signal ES may correspond to, for example, a gravity sensing signal from an accelerometer of G-sensor, and can be used to judge the driver's behavior in stopping, braking, slowing or keeping driving the car C and to determine any driving condition of the car C caused by the driver's driving behavior.

In a still further embodiment, the event signal ES may directly correspond to a certain internal car information provided by, for example, an in-car computer installed in the car C, and the internal car information may be, for example, data about the stepping of the accelerator pedal by the driver, data about the driving speed, data about the stepping of brake pedal by the driver, data about turns made by the driver, fuel consumption data, or data about the use of the directional and other lights of the car by the driver.

The processing unit 26 is electrically connected to the image-capture unit 22 and the sensing unit 24. The processing unit 26 links the event signal ES with corresponding image signal IS, and marks the event signal ES on the corresponding image signal IS. In other words, when the car C encounters with an event and a corresponding event signal ES is generated, the event signal ES will be additionally shown on the image signal IS that is captured at the same time as the occurrence of the event. Therefore, the image signal IS provided by the intelligent driving process recording and reviewing system 2 of the present invention can have the event signal ES marked thereon.

The event signal ES may be marked on the image signal IS in different ways. For example, a tag corresponding to the event signal ES can be embedded in the image signal IS, or an index table may be established to record all the event signals ES and all the image signals IS corresponding to each of the event signals ES.

The memory unit 28 is electrically connected to the processing unit 26, and is used to store the event signals ES and the image signals IS. In the present invention, the memory unit 28 can be a flash memory, a memory card, or a hard disk device.

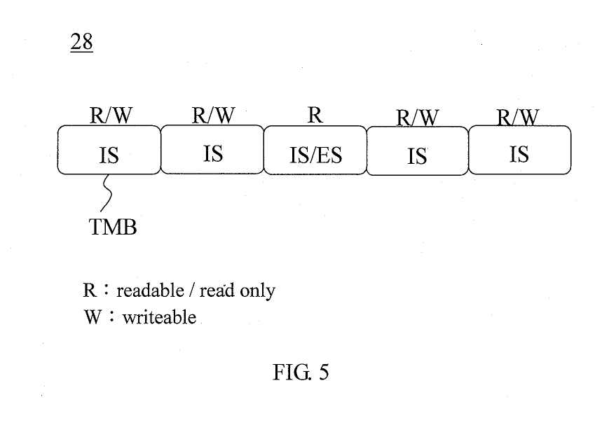

Refer to FIG. 5. According to an operable embodiment, the memory unit 28 includes a plurality of time memory blocks TMB. In each of the time memory blocks TMB, the image signals IS and/or the event signals ES are stored. Further, each of the time memory blocks TMB can be independently set under control to be readable (R) (so called as read-only) or readable/writable (R/W).

For example, when an image signal IS has an event signal ES marked thereon, the time memory block TMB storing that image signal IS can be set to be read-only (R), lest it should be overwritten by newer image signals IS later. In other words, when a series of image signals IS are continuously and sequentially written into the memory unit 28, the memory unit 28 will first determine whether the following time memory block TMB has been set to be read-only (R) or not. If yes, the subsequent image signals IS are written into next available readable/writable (R/W) time memory block TMB; or if no, the subsequent image signals IS are directly written into the following time memory block TMB.

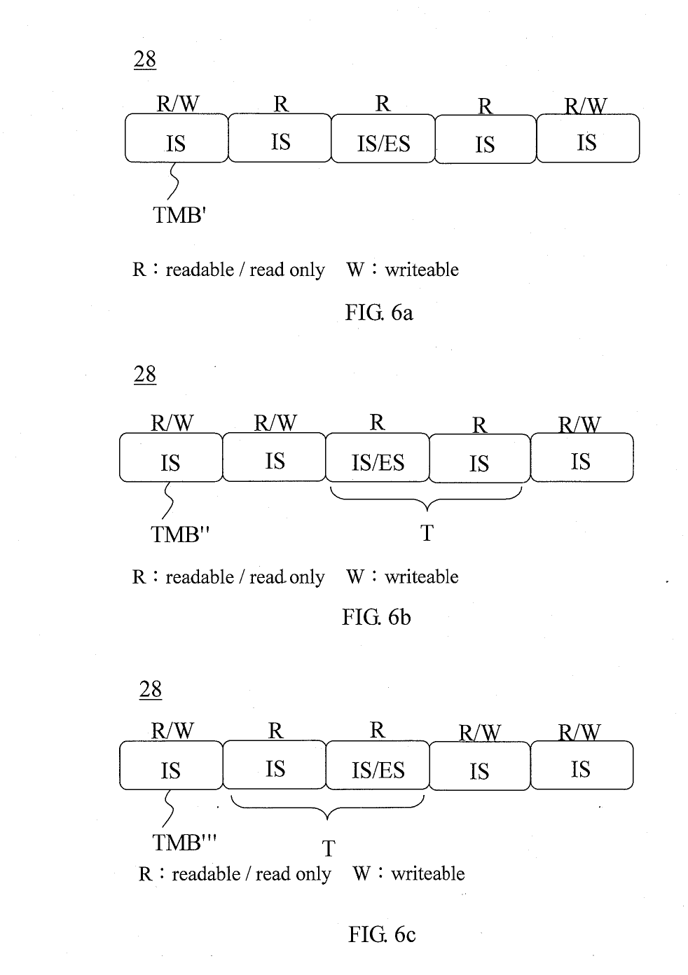

Moreover, the time memory blocks TMB can be set to be read-only (R) in different ways as shown in FIGS. 6a, 6b and 6c.

In a first way as shown in FIG. 6a, when a time memory block TMB storing an image signal IS having an event signal ES marked thereon is set to be read-only (R), other time memory blocks TMB′ immediately preceding and following the read-only time memory block TMB are also set to be read-only (R). Thus, the image signal IS captured at the same time as the generation of the event signal ES as well as the image signals IS captured closely before and after the generation of the event signal ES all are always stored in the memory unit 28 and can not be modified or deleted.

In a second way as shown in FIG. 6b, when a time memory block TMB storing an image signal IS having an event signal ES marked thereon is set to be read-only (R), one or more other time memory blocks TMB″ following the read-only time memory block TMB and corresponding to a preset length of recording time T, such as one minute, are also set to be read-only (R). That is, the image signal IS captured at the same time as the generation of the event signal ES as well as the image signals IS captured within one minute after the generation of the event signal ES all are kept in the memory unit 28 in a read-only manner. In a third way as shown in FIG. 6c, when a time memory block TMB storing an image signal IS having an event signal ES marked thereon is set to be read-only (R), one or more other time memory blocks TMB′″ preceding the read-only time memory block TMB and corresponding to a preset length of recording time T, such as one minute, are also set to be read-only (R). That is, the image signal IS captured at the same time as the generation of the event signal ES as well as the image signals IS captured within one minute before the generation of the event signal ES all are kept in the memory unit 28 in a read-only manner.

The memory unit 28 may store the whole driving process to form a driving track of the car C, which can be used by a map information unit that will be described in more details later.

In a variant of the first embodiment, the intelligent driving recording and inspection system 2 further includes an optional positioning unit 210, as indicated by the dash line box in FIG. 1. The positioning unit 210 is electrically connected to the processing unit 26 for generating a position signal PS corresponding to the position of the car C. The processing unit 26 also links the position signal PS with a corresponding image signal IS, and marks the position signal PS on the corresponding image signal IS. The positioning unit 210 may be, for example, a global positioning system (GPS). And, the position signal PS may be marked on the image signal IS in a manner similar to that for marking the event signal ES on the image signal IS.

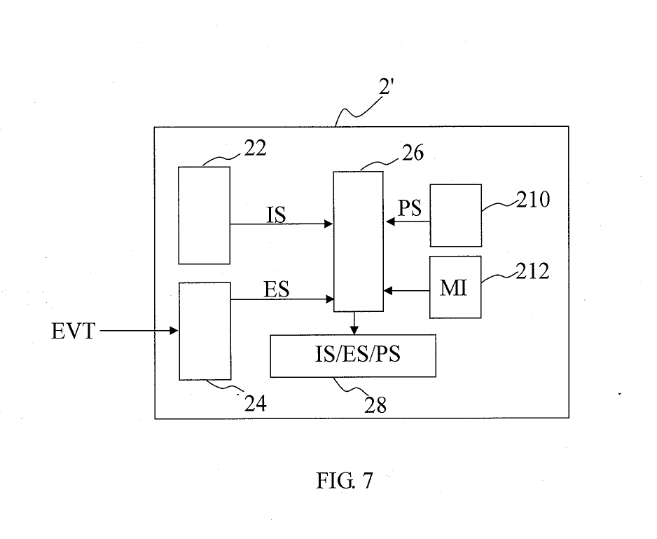

Refer to FIG. 7 that is a block diagram of an intelligent driving recording and inspection system 2′ according to a second embodiment of the present invention. As shown, in addition to the image-capture unit 22, the sensing unit 24, the processing unit 26, the memory unit 28 and the positioning unit 210, the intelligent driving process recording and reviewing system 2′ further includes a map information unit 212 electrically connected to the processing unit 26. The map information unit 212 provides map information MI, and the processing unit 26 marks the event signal ES and the position signal PS on the map information MI according to the position signal PS.

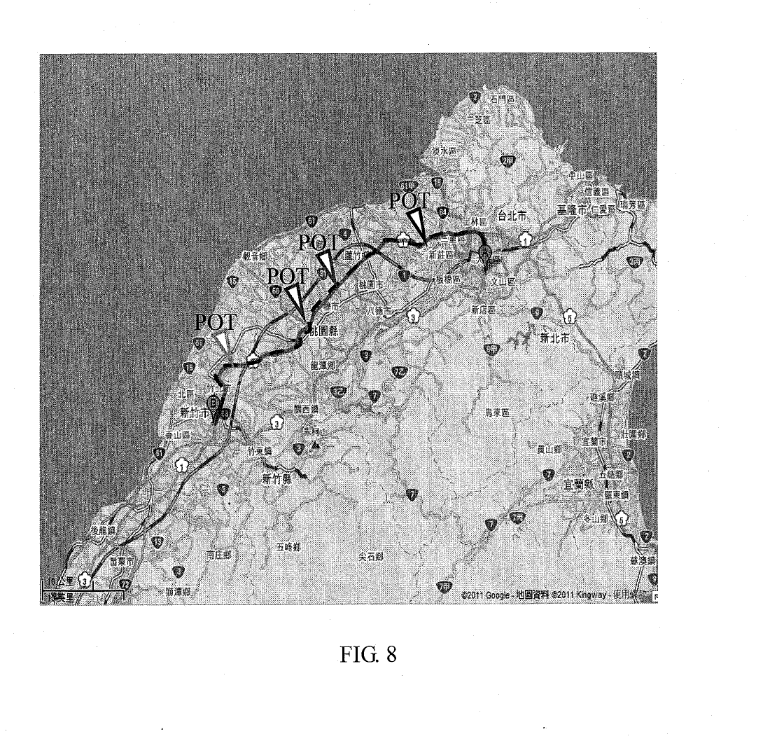

In an embodiment, the event signal ES, the image signal IS, and the position signal PS are marked on the map information MI as tagged points POT, as shown in FIG. 8. Herein, the map information MI is illustrated as a Google Map. The tagged points POT can be shown in different shapes and/or colors to correspond to different events indicated by the event signals ES, such as lane departure, preceding car detection, gravity sensing, and other events indicated by different inside-car driving data. For instance, the lane departure can be marked with a red triangle (LDWS), the preceding car detection can be marked with a yellow triangle (FCW), and the gravity sensing can be marked with a blue triangle (G-sensor).

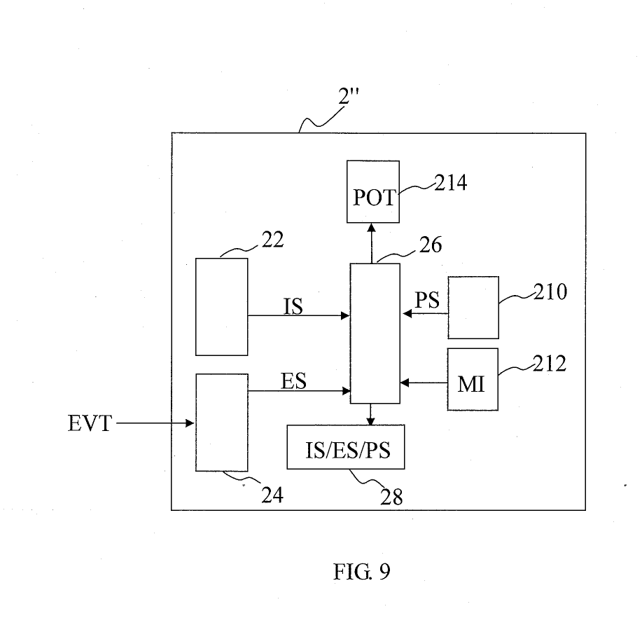

Refer to FIG. 9 that is a block diagram of an intelligent driving recording and inspection system 2″ according to a third embodiment of the present invention. As shown, in addition to all the units included in the second embodiment, the third embodiment further includes a inspection unit 214 electrically connected to the processing unit 26. Via the processing unit 26, the inspection unit 214 allows a user to review the image signals IS, the event signals ES and/or the position signals PS that are stored in the memory unit 28 and corresponding to the tagged points POT.

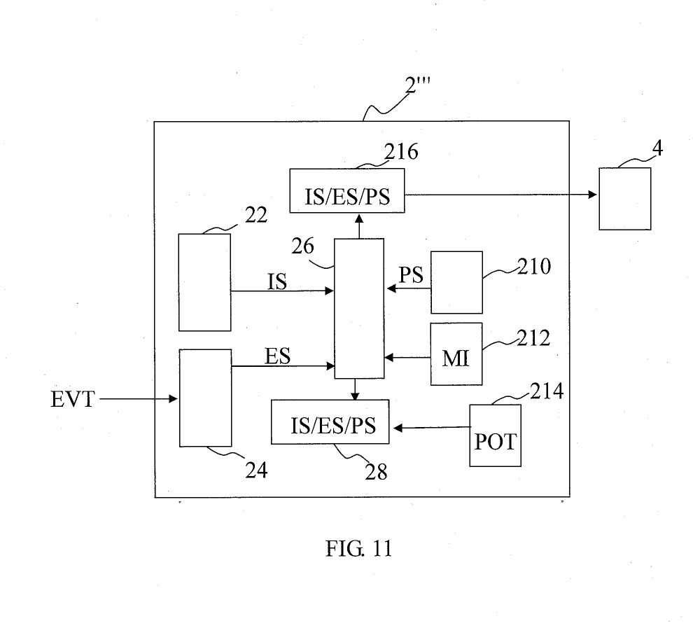

In another embodiment, the inspection unit 214 can directly access the memory unit 28 to read the image signals IS, the event signals ES and/or the position signals PS that are corresponding to the tagged points POT, as shown in FIG. 11.

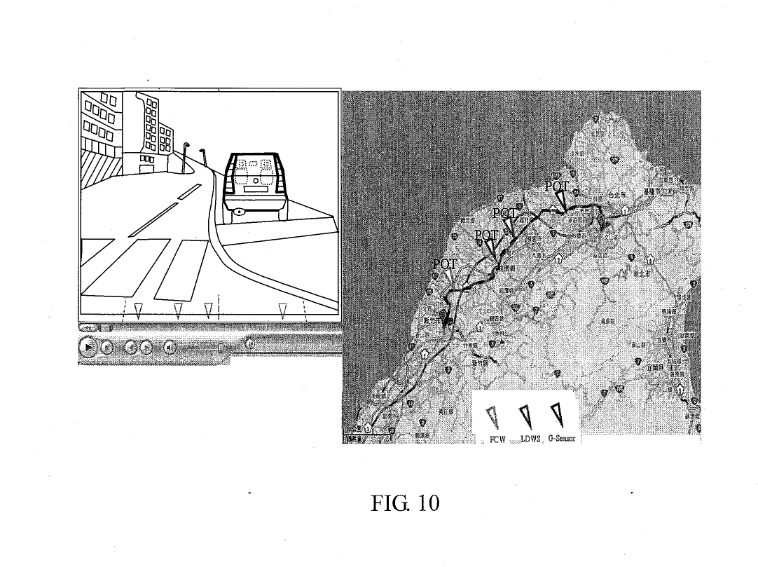

Refer to FIG. 10. In an operable embodiment, the inspection unit 214 works with the map information unit 212 for a user to review the image signals IS, the event signals ES and/or the position signals PS corresponding to the tagged points POT simply by clicking the tagged points POT on the map information MI of the map information unit 212. The inspection unit 214 also allows a user to review the image signals IS, the event signals ES and/or the position signals PS closely before and after the tagged points POT. In other words, the inspection unit 214 allows a user to review the image signals IS, the event signals ES and/or the position signals PS that are captured or generated within a certain length of time T before and after any of the tagged points POT.

Further, a user may also click the map information MI on any position that locates in the driving track corresponding to the car's whole driving process, so as to play back the image signals IS, the event signals ES and/or the position signals PS that correspond to the clicked position.

Refer to FIG. 11 that is a block diagram of an intelligent driving recording and inspection system 2′″ according to a fourth embodiment of the present invention. As shown, in addition to all the units included in the aforesaid embodiments, the fourth embodiment further includes a communication unit 216 electrically connected to the processing unit 26 for transmitting the event signals ES, the image signals IS and/or the position signals PS to an external server 4, so that the driver's driving behavior and the car's driving condition can be monitored or recorded at the external server 4. The external server 4 may be, for example, a driving control center.

In summary, the intelligent driving recording and inspection system according to the present invention detects or senses the car's all driving conditions and the driver's all driving behaviors in the course of driving, captures image signals and generating event signals corresponding to the whole driving process, stores the image signals and the event signals to map information or records them in a text file, and allows a user to access the map information or the text file to easily and quickly review and analyze the event signals and all image signals corresponding thereto, so that the user may easily know his or her driving behaviors and the car's driving conditions in the whole driving process.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An intelligent driving recording and inspection system capable of recording a car's whole driving process for a driver to review the driving process in an intelligent manner, comprising:
an image-capture unit for capturing image signals in the whole driving process;
a sensing unit being installed outside and/or inside the car for sensing all events encountered by the car in the driving process and generating an event signal corresponding to each of the sensed events;
a processing unit being electrically connected to the image-capture unit and the sensing unit; and the processing unit linking the event signals with corresponding image signals and marking the event signals on the corresponding image signals; and
a memory unit being electrically connected to the processing unit for storing the event signals and the image signals thereon.

2. The intelligent driving recording and inspection system as claimed in claim 1, wherein the event signals are generated corresponding to different events sensed by at least one of a lane departure warning system, a forward collision warning system, a G-sensor and/or any inside-car driving data.

3. The intelligent driving recording and inspection system as claimed in claim 2, wherein the inside-car driving data include data about at least one of the stepping of an accelerator pedal by the driver, data about driving speed, data about the stepping of a brake pedal by the driver, data about fuel consumption of the car, data about turns made by the driver and/or data about the use of directional and other lights of the car by the driver.

4. The intelligent driving recording and inspection system as claimed in claim 1, further comprising a positioning unit being electrically connected to the processing unit; the positioning unit generating a position signal corresponding to the car's each position, and the processing unit linking the position signals with corresponding image signals and marking the position signals on the corresponding image signals.

5. The intelligent driving recording and inspection system as claimed in claim 4, wherein the memory unit stores the whole driving process to form a driving track of the car.

6. The intelligent driving recording and inspection system as claimed in claim 5, further comprising a map information unit electrically connected to the processing unit; the map information unit including map information, and the processing unit marking the event signals, the position signals and/or the image signals on the map information.

7. The intelligent driving recording and inspection system as claimed in claim 6, wherein the event signals, the position signals and/or the image signals are marked on the map information as tagged points.

8. The intelligent driving recording and inspection system as claimed in claim 7, wherein the tagged points are shown in different shapes and/or colors to indicate different events sensed by a lane departure warning system, a forward collision warning system, a G-sensor and/or any inside-car driving data.

9. The intelligent driving recording and inspection system as claimed in claim 8, further comprising a inspection unit electrically connected to the memory unit for a user to inspect the image signals, the event signals and/or the position signals corresponding to each of the tagged points.

10. The intelligent driving recording and inspection system as claimed in claim 9, wherein the inspection unit allows a user to review the image signals and the event signals that are captured or generated closely before and after each of the tagged points.

11. The intelligent driving recording and inspection system as claimed in claim 1, further comprising a communication unit being electrically connected to the processing unit for transmitting the event signals and the image signals to an external server.

12. The intelligent driving recording and inspection system as claimed in claim 1, wherein the memory unit includes a plurality of time memory blocks, in each of which the image signals and/or the event signals are stored; and any of the time memory blocks that stores the image signals marked with event signals is set to be read-only.

13. The intelligent driving recording and inspection system as claimed in claim 12, wherein any other time memory blocks immediately preceding and following each of the read-only time memory blocks are also set by the memory unit to be read-only.

14. The intelligent driving recording and inspection system as claimed in claim 12, wherein any other time memory blocks following each of the read-only time memory blocks and corresponding to a preset length of recording time are also set by the memory unit to be read-only.

15. The intelligent driving recording and inspection system as claimed in claim 12, wherein any other time memory blocks preceding each of the read-only time memory blocks and corresponding to a preset recording time are also set by the memory unit to be read-only.
